(19) United States
(12) Patent Application Publication
(10) Pub. No.: US 2025/0070597 A1
(43) Pub. Date: Feb. 27, 2025

(54) ENERGY HARVESTING WITH INDUCTION COIL

(71) Applicant: SCHUNK TRANSIT SYSTEMS GMBH, Wettenberg (DE)

(72) Inventors: Alexander Pachler, Salzburg (AT); Tom Nusch, Wettenberg (DE); Dominik Pascal Arnold, Heltersberg (DE)

(21) Appl. No.: 18/722,281

(22) PCT Filed: Dec. 19, 2022
(86) PCT No.: PCT/EP2022/086680

§ 371 Date: Jun. 20, 2024

(30) Foreign Application Priority Data
Dec. 22, 2021 (DE) 10 2021 134 346.1

(51) Int. Cl. H02J 50/00

(52) U.S. Cl. CPC H02J 50/001; H02J 50/005

(57) ABSTRACT

A power supply device for supplying power to a consumer disposed on a rail vehicle having at least one conductor and the power supply device being configured for generating a supply voltage of the consumer from a voltage applied to the conductor. Transmission electronics and at least one conductor loop connectable in an electrically conductive manner to the consumer via the transmission electronics and having n windings are provided. Transmission electronics is disposed between the conductor loop and the consumer, and the conductor loop disposed about the conductor to generate an outlet voltage, the transmission electronics being designed in such a manner to generate the supply voltage of the consumer from the outlet voltage of the conductor loop. A monitoring system having a power supply device and a method for supplying power to a consumer for monitoring a rail vehicle are also provided.

The invention relates to a power supply device for supplying power to a consumer, preferably an acquisition unit for monitoring rail vehicles, in particular for monitoring an operating unit, the rail vehicle having at least one conductor and the power supply device being configured for generating a supply voltage of the consumer from a voltage applied to a conductor, transmission electronics and at least one conductor loop connectable in an electrically conductive manner to the consumer via the transmission electronics and having n windings being comprised and the transmission electronics being switched between the conductor loop and the conductor loop being disposed in such a manner about a conductor that the conductor loop generates an output voltage, the transmission electronics being designed in such a manner that the transmission electronics generates the supply voltage of the consumer from the output voltage of the conductor loop. Furthermore, the invention at hand refers to a monitoring system having an energy supply device and a method for supplying energy to a consumer for monitoring rail vehicles, in particular for monitoring operating units of the rail vehicles.

In principle, devices and methods are known for supplying power to consumers on rail vehicles and for monitoring rail vehicles and/or their operating units. In the known devices and methods, for example, a state of the operating unit is monitored and/or a measured value and/or data are determined by means of a sensor which is attached directly to the rail vehicle and/or an operating unit. For example, a line pressurized with compressed air can be disposed within a contact strip of a roof current collector, the compressed air escaping from the line if the contact strip breaks or is completely worn and the contact strip is lowered by a contact wire. Alternatively, a pressure force of the contact strip against the contact wire, a wind speed or other environmental and operating parameters can be measured by means of an appropriately installed sensor and be used to control the actuation of the roof current collector or another operating unit of the rail vehicle.

Numerous sensors can be used to monitor the operating units, the sensors being able to be powered either by cable or wirelessly. A wired power supply, which draws power directly from a power grid, is usually associated with high material costs and high cabling costs or is ruled out due to the power supply requirements. For example, in mobile applications, such as the use of an acquisition unit with sensors in or on means of transportation, such as trains, cars or aircrafts, a self-sufficient or wireless or off-grid power supply is often preferred to a wired power supply due to the requirements. Known acquisition units with sensor systems which have a wireless power supply, i.e. are not directly connected to a power supply, are usually supplied with electrical energy solely via batteries or accumulators. However, this has the disadvantage that the battery has to be replaced or the accumulator recharged regularly, which means that the acquisition unit requires more maintenance. In addition, external influences can severely affect the service life of the batteries or accumulators. For example, temperature fluctuations can lead to faster discharge or, depending on the time of year and/or climatic conditions shorter maintenance intervals may be necessary, especially in cold weather. Especially if the consumer, the acquisition unit and the power supply unit are difficult to access, this is associated with increased effort and is therefore undesirable.

It is therefore the object of the invention at hand to propose a power supply device and a method for locally generating voltage and supplying power to a consumer disposed on a rail vehicle, the power supply device not requiring a battery, an accumulator or a complex cable connection supplying power.

This object is attained by a power supply device with the features of claim 1.

In current collectors operated in AC (alternating current) rail networks, the induction principle can be used to generate an electric voltage via a conductor loop having n windings and being placed about a live element, such as the conductor, disposed at the current collector, for example, and to make usable a monitoring system for power supply.

Likewise in DC (direct current) current networks, the device according to the invention can be used to measure the ripple voltage or the voltage drop when loaded. Direct current generally has an alternating voltage portion which also allows using the direct voltage per induction at high voltage levels if required.

A device according to the invention for supplying power to a consumer disposed on a rail vehicle, the consumer preferably being an acquisition unit for monitoring rail vehicles, in particular for monitoring operating units, the rail vehicle having at least one conductor, is configured for generating a supply voltage of the consumer from a voltage applied to a conductor. In particular, a sufficient current flow through the conductor has proven essential, as a magnetic field is generated via the current flow. In other words, the current resulting from the voltage applied to the conductor generates the electromagnetic field, which in turn can be used for generating the supply voltage of the consumer via the conductor loop.

For supplying power to the consumer, the power supply device comprises transmission electronics and at least one conductor loop connectable in an electrically conductive manner to the consumer via the transmission electronics, the transmission electronics being switched between the conductor loop and the consumer. The conductor loop having n windings and preferably designed as an induction coil is placed about the conductor and is connected to the rail vehicle, in particular a current collector of the rail vehicle, by means of at least one fastening mechanism. The conductor loop can have a toroid and windings wound about the toroid, the toroid being able to be slid over the conductor. Several conductor loops, in particular several different conductor loops engaging about a conductor, can be switched in series or parallel. Moreover, it is also possible to slide several conductor loops over only one conductor and to switch these parallel or in series. The conductor loop is preferably designed such that an overload of the system is prevented by means of the saturation of the toroid. The number of windings, the size and the material of the conductor loop can be selected such that the maximum output is achieved.

Preferably, the conductor loop is designed as an induction coil and has a toroid and windings placed about the toroid. The conductor loop can have between 300 and 750 windings. A conductor loop having 650 windings has proven to be particularly advantageous. The toroid can be designed geometrically as a toroidal core, a round blank, a tube section or a circular body having a hole in the center. To produce the conductor loop, in particular the windings of the conductor loop, the toroid can be wrapped with a wire-shaped conductor. The toroid preferably has an inner diameter between 15 mm and 30 mm and an outer diameter between 25 mm and 40 mm at a height between 6 mm and 18 mm. It has proven to be particularly advantageous when the toroid has an inner diameter between 24 mm and 25 mm and an outer diameter between 29 mm and 30 mm at a height between 16 mm and 17 mm. Further preferably, the toroid has a magnetic relative permeability between 30,000 and 60,000. Particularly preferably, the toroid is made of a material having a magnetic relative permeability between 45,000 and 48,000. It is conceivable for the toroid to be made in multiple, preferably two, pieces to allow a simple fixation to a conductor already fixed to the rail vehicle. The multiple-piece design allows placing the toroid and/or the conductor loop about the conductor in a simple manner, without having to remove the conductor. The conductor loop can have an ohmic resistance between 1.5 ohms and 6 ohms. Particularly preferably, the conductor loop has an ohmic resistance between 4.2 ohms and 4.7 ohms, most preferably 4.5 ohms.

From the voltage generated via the conductor loop, the supply voltage of the consumer is generated by means of the transmission electronics. This enables local voltage generation and supply to the consumer, i.e., in the immediate vicinity of the consumer.

The current collector can be designed in the manner of a pantograph.

In the context of the invention, the consumer can be designed as an acquisition unit and the acquisition unit can have a sensor device fixedly disposed on the corresponding operating unit or the rail vehicle. The sensor device can then, for example, comprise a sensor with which, for example, a function of the corresponding operating unit and an operating duration can be determined. If the acquisition unit also comprises a transmission device, it can transmit data sets to a superordinate unit, such as the names of the operating unit or the values detected by the sensor.

In the context of the invention, operating units can be current collector, ground contacts, lubricating devices, contact strips, grinding devices, contact brushes, ground brushes or the like.

In the context of the invention, a current collector can be designed as a roof current collector, a roof charging current collector, an inverted roof charging current collector, an underfloor current collector or a third-rail current collector.

In the context of the invention, a conductor relates to a conductor which supplies the rail vehicle with current. Preferably, the conductor is a main conductor which supplies the rail vehicle from a superordinate power grid. Preferably, the main conductor connects the motor of the rail vehicle to a current transfer point, which is formed, for example, between a current collector and a catenary supplied with high voltage. A current collector can thus comprise a part of the main current conductor and/or at least one conductor of a rail vehicle. The main current conductor also preferably supplies components of the rail vehicle, such as the drive motor of the rail vehicle, with high voltage. A catenary commonly used in Germany is at a high-voltage potential of 15 kV with respect to the ground potential. However, it is also conceivable to operate the device according to the invention in other known traveling current networks. Depending on the type of power supply, i.e., direct current or alternating current, and the voltage applied, rail vehicles with an electrical output in the range of several MW draw electrical currents of up to several 1000 A from a catenary of this kind. This supply to the rail vehicle takes place from the transfer point by means of the main conductor and a distribution system connected thereto, which can include a large number of conductors. In order to prevent damage due to the high potential difference, especially when disposed on the roof of a rail vehicle, the power supply device and/or the consumers can be operated isolated on the conductors, in particular on the main conductor, without having an electrical connection to the rail vehicle body.

The power supply device according to the invention can also be used to supply a plurality of consumers with energy. Thus, the power supply device according to the invention can also be used to supply a plurality of acquisition units, which acquire data at different points of a rail vehicle, with energy and can thus be operated without a battery or accumulator.

The transmission electronics is designed in such a manner that the transmission electronics generates the supply voltage of the consumer from the outlet voltage of the conductor loop. Thus, the transmission electronics according to the invention makes it possible to adapt the outlet voltage of the conductor loop in such a manner that the consumers can be supplied with voltage without damaging the consumers itself or impairing the operation of the consumer. This is because the outlet voltage of the conductor loop can, for example, be subject to voltage fluctuations and/or have voltage peaks which should not be passed on to the consumers in the course of supplying the consumer.

With the power supply device according to the invention, it is thus possible to supply a consumer, in particular an acquisition unit, with electrical energy in a simple and reliable manner without having to use batteries or accumulators susceptible to maintenance. In the context of the invention, a battery is a storage device for electrical energy which is completely stored in electrochemical form in a battery. In the context of the invention, an accumulator is a rechargeable battery.

By attaching a simple conductor loop, which is placed about a conductor, a complex structure and complex cabling or cabling are also avoided.

It is conceivable that the outlet voltage of the conductor loop is used unchanged by means of the transmission electronics as the supply voltage for supplying the consumer. According to a preferred embodiment, however, the transmission electronics can also have a component for current or voltage transformation, by means of which the outlet voltage of the conductor loop is transformed so that the outlet voltage of the conductor loop and the supply voltage of the consumer differ. In the context of the invention, a component for current or voltage transformation can be designed as a component for current or voltage limitation or as a component for current or voltage reduction or as a component for current or voltage increase. A component for voltage transformation can, for example, be an AC voltage converter or a DC voltage converter. A DC/DC converter is an electrical circuit that converts a DC voltage supplied to the input into a DC voltage with a higher, lower or inverted voltage level. In the context of the invention, an AC voltage converter is an electrical component which converts an AC input voltage, which is present at the input of the AC voltage converter, into an AC output voltage, which can be tapped at the output of the AC voltage converter. The outlet voltage of the AC voltage converter can be less than, greater than or equal to the inlet voltage of the AC voltage converter. The voltage is preferably increased using a boost converter whose outlet voltage is always greater than its inlet voltage. The outlet voltage of the conductor loop is preferably reduced using a buck converter whose outlet voltage value is always less than its inlet voltage value. For example, an inlet voltage of the voltage transformation component of between 0.35 V and 16 V can be converted into an outlet voltage of 3.8 V by means of the voltage transformation component. In this manner, the supply voltage of the consumer can be provided reliably and advantageously. Preferably, the voltage transformation component provides a DC voltage. Further preferably, the voltage transformation component provides a low voltage of 3.8 V. Most preferably, the voltage transformation component provides a DC voltage of 3.8 V. The voltage transformation can take place before or after rectification independently of rectification.

The transmission electronics can have a component for rectification. The component for rectification can rectify an AC voltage tapped from the conductor loop and subsequently supply a DC voltage to the consumer as the supply voltage. Known rectifiers can be used as components for rectification. Semiconductor rectifiers are preferred.

Alternatively or in addition to a component for rectification, the transmission electronics can have a component for current or voltage limitation. Such a component for current or voltage limitation allows protection against overvoltage or excessive currents in a simple manner. This ensures that downstream components of the transmission electronics or the consumer are not damaged or impaired in their function by overvoltage or excessive currents. Electrotechnical components such as suppressor diodes or varistors, which provide discrete overvoltage protection, can be used as voltage limiting components. Preferably, however, an active limiter is used as a component for current or voltage limitation. Such an active limiter continuously measures the voltage or the current on the supply line of the active limiter and isolates the downstream elements in the event of overvoltage and/or excessive current flow. An active voltage limiter is particularly preferred. Should the conductor loop supply AC voltage, the AC voltage must be rectified before being fed to the consumer, which preferably takes place with the aid of an active limiter in combination with a rectifier.

The transmission electronics of the power supply device can be designed in such a manner that the transmission electronics has a charging electronics, which has at least one component for energy storage, preferably at least one capacitor. The energy storage can be used to bridge the times when the voltage drop at the conductor loop is too low or non-existent and therefore the conductor loop does not provide a sufficient outlet voltage to generate a supply voltage for the consumer. This ensures the consumer can be operated reliably even during an insufficient supply from the conductor loop, for example during downtimes in the train depot or during short braking phases during operation. The preferred component for energy storage is a capacitor which is supplied via the charging electronics. Even more preferably, a so-called supercapacitor, which is supplied via the charging electronics, is used as an component for energy storage. It is also conceivable that a component for voltage transformation and/or a component for rectification and/or a component for current or voltage limitation are also supplied with power from the energy storage device. It is also conceivable that when the energy storage system is completely discharged, the system is supplied by an additional emergency battery which can be replaced if necessary. However, as this emergency battery is only used in exceptional cases, its maintenance and replacement intervals are comparatively long.

The power supply device can have a monitoring electronics for monitoring the voltage transformation component, in particular a voltage transformer. The voltage transformation component can be initially ignited via a pulse preferably generated by the component for energy storage. The monitoring electronics for monitoring the voltage transformation component monitors in particular the initial ignition of the voltage transformation component, preferably a voltage transformer, and prevents unnecessary ignition processes, for example if an outlet voltage of the conductor loop is unstable. In this manner, the monitoring electronics contributes to the safe operation of the consumer and prevents unnecessary discharging of the component for energy storage by preventing unnecessary ignition processes.

The supply voltage of the consumer, in particular an acquisition unit, which can be provided by the transmission electronics connected downstream of the conductor loop, is preferably 3.3 V. If charging electronics are provided, their inlet voltage is preferably 3.8 V and the inlet voltage of the voltage transformation component is preferably 0.35 V to 16 V. Since the supply voltage must be adapted to the consumer's requirements, it is also conceivable that if the voltage which can be tapped at the conductor loop and is lower than the supply voltage required to supply the consumer is comparatively low, an increase in the voltage tapped at the conductor loop is necessary.

The power supply device can have at least one conductor loop, which is disposed about a conductor disposed on a current collector. Preferably, the conductor loop concentrically encloses the conductor disposed on a current collector. Further preferably, the conductor is designed as a cable element and the conductor loop is disposed about the cable element. Since the power supply device, in particular the conductor loop, can be directly disposed on a current collector via a fastening mechanism, advantageously no intervention in the internal on-board network of the rail vehicle is required, whereby a universal use on different rail vehicles irrespective of the rail vehicle operator becomes possible.

The current collector can be electrically isolated from the wagon body of a rail vehicle. In this case, a power source at the current collector outside of the wagon body is required to operate electrical systems such as acquisition units for monitoring the rail vehicle on the current collector, the power source being able to be provided by disposing the power supply device according to the invention on the current collector.

If the power supply device is disposed on the current collector, the power supply device can be easily accessed, without requiring access to the interior of the rail vehicle and/or the wagon body or access to the interior on-board network of the rail vehicle. Advantageously, no access to the train system, the hardware or software of the rail vehicle or the current path is consequently required, thereby making the power supply system particularly safe and easy to implement and fulfilling requirements for admitting rail vehicles. It is even conceivable for an admission not being required owing to the design and position of the power supply device on the current collector.

In particular when the power supply device is meant to supply an acquisition unit for monitoring a current collector with power, it has proven advantageous for the power supply system to be disposed on the current collector, and thus on the operating unit and in the vicinity of the acquisition unit, to minimize transmission paths.

In order to enable a particularly simple and reliable provision of the at least one conductor loop on a current collector, the conductor loop of the power supply system can advantageously be disposed at the base frame, the upper arm and/or the lower arm of the current collector. Preferably, the conductor loop is disposed about a section of the conductor designed as a flexible cable element, the cable element bridging a bearing of a joint between the base frame and the lower arm or a bearing of a joint between a lower arm and an upper arm.

It is also conceivable for the conductor loop to be placed about a section of the conductor provided on the base frame of the current collector, the section of the conductor being provided on the base frame by means of a fastening mechanism.

Alternatively or additionally, a conductor loop can be placed about an adapter element, which is fixed on the current collector via a fastening element of the fastening mechanism. Preferably, the adapter element is live. Further preferably, the section of a conductor provided on the current collector is designed as a cable element, in particular a flexible cable element.

It is further conceivable for several conductor loops to be disposed on a current collector, in particular on the base frame of the current collector. Preferably, four conductor loops are disposed on the current collector. Further preferably, the current collector has four conductors, one conductor loop being disposed on one conductor each. Most preferably, one conductor loop is disposed on one section of a conductor bridging a joint between the base frame and the lower arm.

To bridge an insufficient supply of electrical energy to the conductor and thus an insufficient supply to the consumer, the power supply device can include an power generation unit. It is conceivable that the power generation unit is designed as a fuel cell, a photoelectric generator, a piezoelectric generator, a kinetic generator and/or a thermoelectric generator. For example, energy from various energy sources such as wind power, photovoltaics, dynamic pressure, kinetic energy, for example due to movement of an operating unit or a component of an operating unit, temperature gradients or pressure changes, can be used to provide energy to the consumer by means of the power generation unit. The power supply device can have a power generation unit in addition to the conductor loop. However, it is also conceivable that the power supply device consists only of a power generation unit and transmission electronics, without a conductor loop being included in the power supply device, so that completely self-sufficient operation is possible without being dependent on an external power grid.

The monitoring system according to the invention has at least one power supply device according to the invention and a consumer designed as an acquisition unit and serving to monitor rail vehicles, in particular for monitoring operating units, data being able to be recorded for various attributes of the corresponding operating units by means of the acquisition unit. Operating units of rail vehicles to be monitored by the acquisition unit can be, for example, current collectors, ground contacts, lubricating devices, contact strips, sliding devices, contact brushes, ground brushes, shaft ground systems or the like. In the context of the invention, an attribute is understood to be an object-specific property of an operating unit. The attributes can be selected from the attribute types type, identification, year of manufacture, vehicle, use, running time, material, wear, fault, damage, location, image, sound, recording time or the like of the operating unit. In the context of the invention, data is understood to mean attribute values, such as an actual measured value for recording the wear of an operating unit. The data can be, for example, a designation, a serial number, a year, a date, a vehicle type designation, a measured value, a fault description, a damage description, a position specification, an image file, a sound file, a time, a time period or the like.

If the operating unit is a roof current collector and/or a pantograph, the following attributes can preferably be used: type of collector strip, material of the collector strip, initial height and wear height, running time of the vehicle in kilometers, running time of the current collector in kilometers, wear specification in millimeters for a first collector strip, wear specification in millimeters for a second collector strip.

If the operating unit is a third-rail current collector, the following attributes can preferably be used: type of fuse, type of collector strip, material of the collector strip, initial height and wear height, running time of the vehicle in kilometers, running time of the current collector in kilometers, wear specification in millimeters for the collector strip.

If the operating unit is a ground brush, the following attributes can preferably be used: collector ring material, brush material, brush cross section, initial height and wear height, running time of the vehicle in kilometers, running time of the ground contact in kilometers, wear specification in millimeters for several carbon brushes.

If the operating unit is a shaft ground system, the following attributes can preferably be used: parallel-feed material, fiber material, fiber cross section, initial cross section and wear height, running time of the vehicle in kilometers, running time of the ground system in kilometers, wear specification in millimeters for a first fiber and a second fiber.

If the operating unit is a wheel flange lubrication system, the following attributes can preferably be used: lubricating pin material, initial length and wear length, running time of the vehicle in kilometers, running time of the lubricating pin in kilometers, wear specification in millimeters.

The monitoring system according to the invention can also be used to monitor rail vehicles having several operating units of the same and/or different types. It is conceivable for the monitoring system to also have a plurality of acquisition units for recording data from the operating units. The plurality of acquisition units can each be connected to a separate power supply device or an individual power supply device can supply a plurality of acquisition units with power.

Advantageously, the data recorded by the acquisition units for different attributes of an operating unit can be assigned to these attributes. The data can be represented by values, characters or files. Together with the assigned data, the attributes form data sets which can be transmitted from the respective acquisition units to a monitoring unit. The monitoring unit can be part of the monitoring system or belong to another system as a superordinate and/or secondary unit. It is conceivable that the monitoring system has several acquisition units, whose data sets are transmitted to at least one individual monitoring unit and are merged in this unit, several monitoring units also being able to be present, for example for different applications. The data sets can be stored in a database of the monitoring unit and be processed continuously or as required by an evaluation device of the monitoring unit. The monitoring unit and/or the evaluation device can be formed by a computer with a software application installed thereon. In order to correlate the data sets with each other, a pattern analysis of the data sets can be carried out by means of the evaluation device and output using an output device, for example a screen. The pattern analysis makes it possible to determine an interrelationship between data sets, provided one exists. In turn, causal relationships can be regularly derived from the correlations, the causal relationships being able to be used to optimize the operation of the monitored rail vehicles. For example, an occurrence of a fault on a certain type of operating unit can correlate with a certain type of rail vehicle. This makes it possible to determine the cause of the fault and/or the cause-effect relationship between the rail vehicle and the fault and to eliminate it in a targeted manner.

The monitoring system can comprise an acquisition unit which has a sensor device fixedly disposed on the corresponding operating unit or the rail vehicle. The sensor device can then, for example, comprise a sensor with which a function of the corresponding operating unit and an operating time can be determined. For example, the sensor device can be used to record data relating to the wear of a component of an operating unit. Preferably, the sensor device is used to detect the wear of a current collector, more preferably a contact strip of a current collector.

The acquisition unit of the monitoring system can have a transmission device fixedly disposed on the corresponding operating unit or the rail vehicle. This transmission device can then transmit datasets, in particular data recorded by a sensor device, preferably to a monitoring unit. For example, the transmission device can transmit a data set consisting of the type designation of the operating unit and a value determined by the sensor as well as an operating time. The transmission device then assigns the data recorded for the sensor to the corresponding attributes. It may also be the case that the transmission device already stores data sets which are transmitted, such as a serial number or a year of manufacture of the operating unit or of the rail vehicle. The data can be transmitted via a data connection. In principle, the data connection can be formed by a cable connection. Furthermore, the data connection can be a radio connection or another suitable type of data connection. The data connection can be established continuously, at regular intervals or event-based. Overall, this makes it possible to use the transmission device to transmit data sets of the operating units, regardless of the type of data connection, for example for evaluation. It is conceivable that the data connection is established via an external network. The data connection can be established via a mobile network, WLAN, a satellite connection, the Internet or any other wireless standard, either on its own or in combination. The destination of the data transmitted by the transmission device, for example a monitoring unit or evaluation device, can then also be spatially distanced from the operating units, the rail vehicles and/or the transmission device. In particular, this makes it possible to centrally evaluate data sets of a rail vehicle.

The acquisition unit of the monitoring system according to the invention can have a time sensor and a position sensor, making it possible to determine an acquisition time and a local position of the corresponding operating unit. The acquisition time and the local position can also each be stored as a data set in a database. The local position can, for example, determine a position of the rail vehicle and/or the relevant operating unit via satellite navigation. This makes it possible, among other things, to determine at which point on a route a particular data set was recorded. This makes it possible to assign the relevant local position to an event and/or the data set recorded at this point in time. If a pattern analysis is carried out, correlations can then be established, for example, between the local position recorded in the acquisition time and any errors detected in the operating units. For example, a comparatively increased wear or a specific fault on the operating unit can then be assigned to a season or a route.

The monitoring system according to the invention, in particular the acquisition unit, can have an energy meter. This energy meter is preferably designed as a current measuring device and/or voltage measuring device. The conductor loop is also preferably used to measure the voltage dropping at the conductors, which is proportional to the current via the resistance of the conductor, the current in turn allowing to draw conclusions regarding the energy via the mains voltage, in particular via the mains voltage of the catenary. The energy meter can be used, for example, to detect the traveling current applied to the main conductor and/or the voltage tapped by the conductor loop and/or the amount of electrical energy fed back into the network by the rail vehicle and/or the electrical energy transmitted by the conductor loop to the transmission electronics and/or the electrical energy transmitted by the conductor loop to the acquisition unit. Preferably, the traveling current applied to the main conductor and/or the voltage tapped by the conductor loop and/or the amount of the electrical energy supplied back to the network by the rail vehicle and/or the electrical energy transmitted by the conductor loop to the transmission electronics and/or the electrical energy transmitted by the conductor loop to the acquisition unit is detected while taking into consideration the power distribution or the measurement of the total current consumption of the rail vehicle. In addition, such an energy meter can be used to detect arcing, i.e., to detect electrical arcs, for example between the catenary and the contact strip of a current collector, due to voltage changes, in particular due to a strong voltage drop. Moreover, a travel profile of the rail vehicle can be recorded and modeled by evaluating the energy yield. The measurement of the traveling current, i.e., the current flowing through the main conductor, is preferably carried out by recording the negative half-wave or the positive half-wave in alternating current networks and/or by a high-impedance voltage measurement circuit.

The monitoring system can comprise at least one operating unit. The monitoring system can also comprise several operating units, whose data can be stored as data sets in a database. The operating units can be connected to a superordinate evaluation device via the acquisition unit and/or a transmission device with a data connection. For example, the monitoring system can have a current collector, a ground contact, a lubricating device, contact strips, sliding devices, contact brushes or ground brushes as operating units. Preferably, the monitoring system comprises a current-carrying operating unit, such as a current collector, a sliding device or contact brushes. Particularly preferably, the monitoring system comprises a current collector as an operating unit, on which the conductor loop of the power supply device is disposed. The monitoring system can also comprise a plurality of acquisition units for monitoring several current collectors.

In the method according to the invention for supplying power to a consumer disposed on a rail vehicle, in particular an acquisition unit for monitoring rail vehicles, a first voltage is applied to a conductor of the rail vehicle, in particular to a current collector, and a second voltage is tapped at the conductor as the outlet voltage of the conductor loop by means of at least one conductor loop, the outlet voltage of the conductor loop being used to supply power to the consumer. Preferably, the conductor is a main conductor for supplying power to the rail vehicle. Preferably, the acquisition unit is designed for monitoring operating units of a rail vehicle.

In principle, in order to avoid unnecessary repetition with regard to the features, properties and advantages of the method according to the invention, reference should be made to the above disclosure of the power supply device according to the invention and the monitoring system according to the invention. This means that, in principle, features disclosed and described in terms of the method are to be regarded as described and claimable in terms of the device, and vice versa.

Preferably, the consumer is designed as an acquisition unit and the acquisition unit, which can be supplied with power by the power supply method according to the invention, is used to monitor current collectors, ground contacts, lubricating devices, contact brushes, sliding devices, contact brushes, ground brushes or the like.

In order to use the outlet voltage of the conductor loop to supply power to the consumer, the outlet voltage of the conductor loop can be used directly as the supply voltage of the consumer or be fed to transmission electronics by means of which the outlet voltage of the conductor loop is converted, stabilized and/or the electrical energy transmitted by the conductor loop is stored.

Advantageously, the supply voltage required by the consumer is generated by voltage transformation of the outlet voltage of the conductor loop. This can take place in the transmission electronics. Components for voltage transformation, such as a voltage converter or a voltage transformer, are preferably used for voltage transformation. The step of transforming voltage makes it possible to reliably provide the required supply voltage for the consumer. In the context of the invention, the term “transforming the outlet voltage of the conductor loop” refers to limiting or reducing or increasing the outlet voltage of the conductor loop. By limiting or reducing the voltage, it can be ensured that the consumer is not damaged by voltage peaks or the like. However, it is also conceivable to increase the outlet voltage. The outlet voltage of the conductor loop is preferably increased using a boost converter whose outlet voltage is always greater than its inlet voltage. The outlet voltage of the conductor loop is preferably reduced by using a buck converter, whose outlet voltage is always less than its inlet voltage. The voltage transformation can take place before or after rectification, irrespective of rectification.

The outlet voltage of the at least one conductor loop can be rectified. Rectification makes it possible to supply the consumer with DC voltage, regardless of whether the conductor loop generates AC or DC voltage. Preferably, the outlet voltage of the conductor loop is rectified and then subjected to a voltage transformation. It is further preferred that the outlet voltage of the conductor loop is limited and rectified and then subjected to a voltage transformation.

The supply voltage of the consumer can be provided at least temporarily by at least one component for energy storage. This offers the advantage that the consumer, in particular an acquisition unit, can be supplied from the energy storage unit regardless of faults or failures in the supply to the conductor. Preferably, a voltage tapped at the conductor loop is rectified and/or limited and the electrical energy is then supplied to an component for energy storage, with the component for energy storage providing the supply voltage required to supply the consumer.

As part of the method according to the invention, the traveling current can be determined and/or arcs can be detected and/or a travel profile can be recorded. The traveling current and the current and/or voltage curves on the conductor can be determined via the properties of the bypass conductor. Furthermore, the quality of the power supply of the rail vehicle can be determined, as this property correlates with traveling current consumption, and in particular fluctuations of the traveling current allow drawing conclusions regarding the quality of the power supply. To determine the traveling current consumption and thus to determine the quality of the power supply, the power distribution can be taken into consideration or the total current can be measured, for example by applying several conductor loops.

Due to the characteristics of an arc, arc detection is possible in a simple manner by determining the voltage at the conductor loop. For when an arc occurs, for example between the contact strip of a current collector and the catenary, characteristic voltage changes and/or a reduction in the current flow through the conductor loop can be detected. This means that the undesired occurrence of arcing can be detected and appropriate measures can be taken to service the supply network and/or the rail vehicle, in particular the current collector.

As the energy consumption via the main conductor from the supply network correlates with the energy yield of the conductor loop, a travel profile of the rail vehicle can be derived from the energy yield of the conductor loop. In particular, acceleration and braking processes of the rail vehicle can be linked with time and/or position data within a travel profile, for example to improve route expansion, route maintenance or route simulations. The data required for the travel profile, in particular data relating to braking processes and/or acceleration processes, can be derived from the energy yield of the conductor loop in a simple manner, as an acceleration process, in which the main conductor transmits an increased amount of energy, can be presumed when the energy yield of the conductor loop is increased, and the energy yield is lower during a braking process, as the main conductor only transmits a small amount of energy.

In the following, a preferred embodiment of the invention is explained in more detail with reference to the attached drawings.

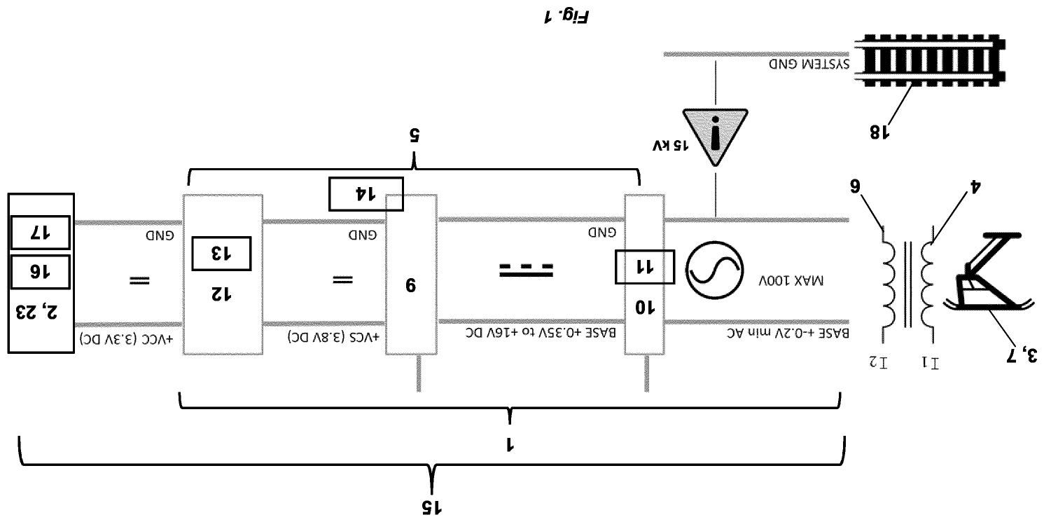

FIG. 1 shows a schematic representation of a monitoring system according to the invention with a power supply device disposed on a current collector.

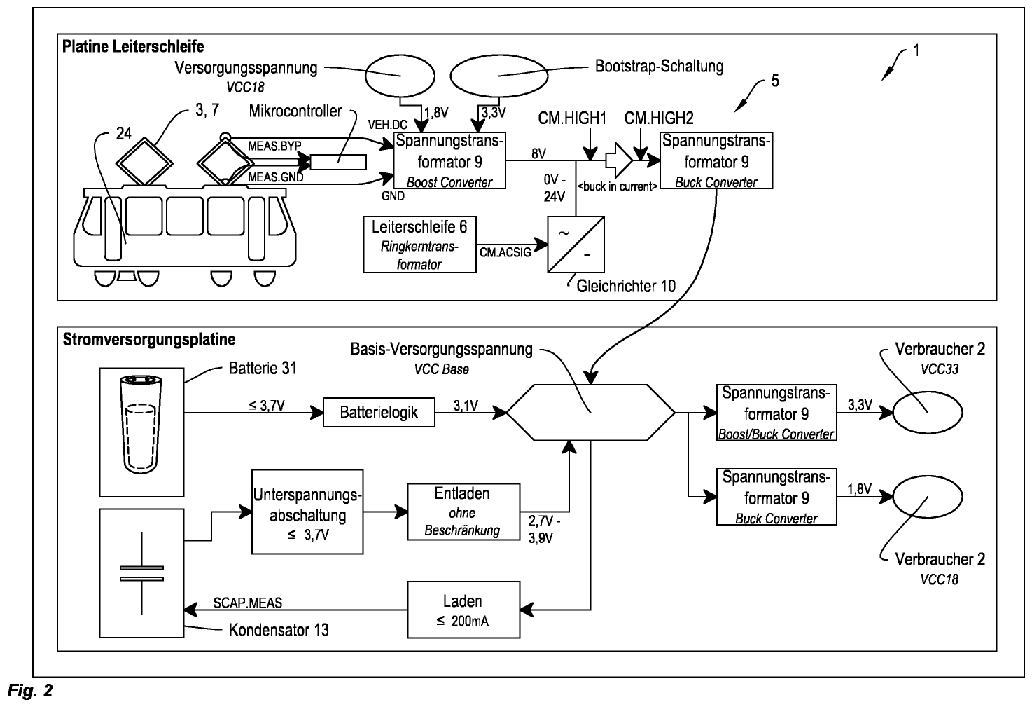

FIG. 2 shows a schematic representation of a power supply system according to the invention.

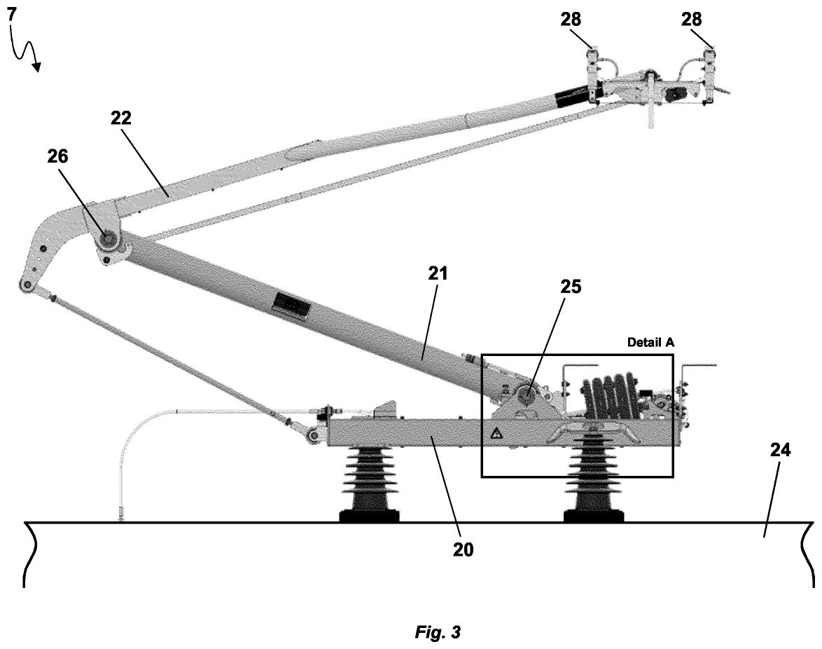

FIG. 3 shows a positioning of a fastening mechanism on a pantograph.

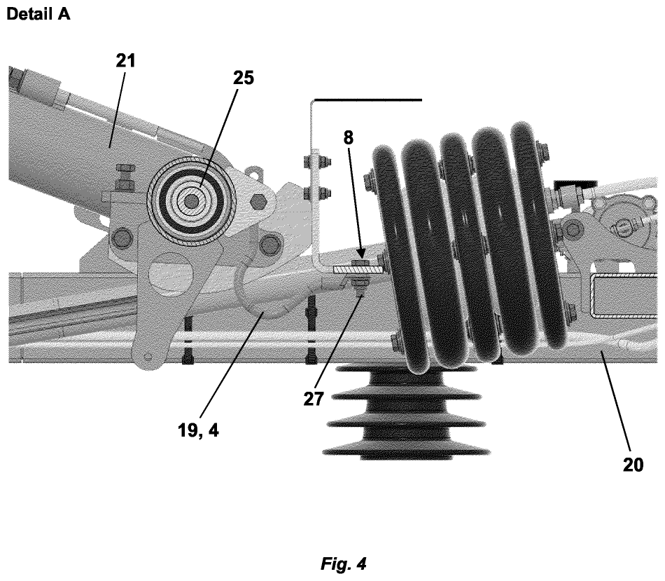

FIG. 4 shows detail A from FIG. 2 of the positioning of a fastening mechanism on a pantograph.

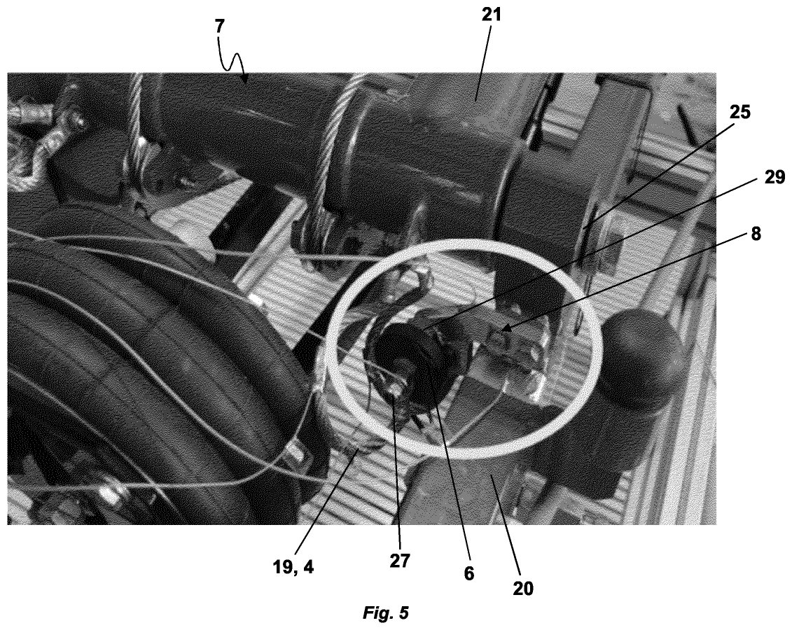

FIG. 5 shows a positioning of a conductor loop on a pantograph by means of a fastening mechanism.

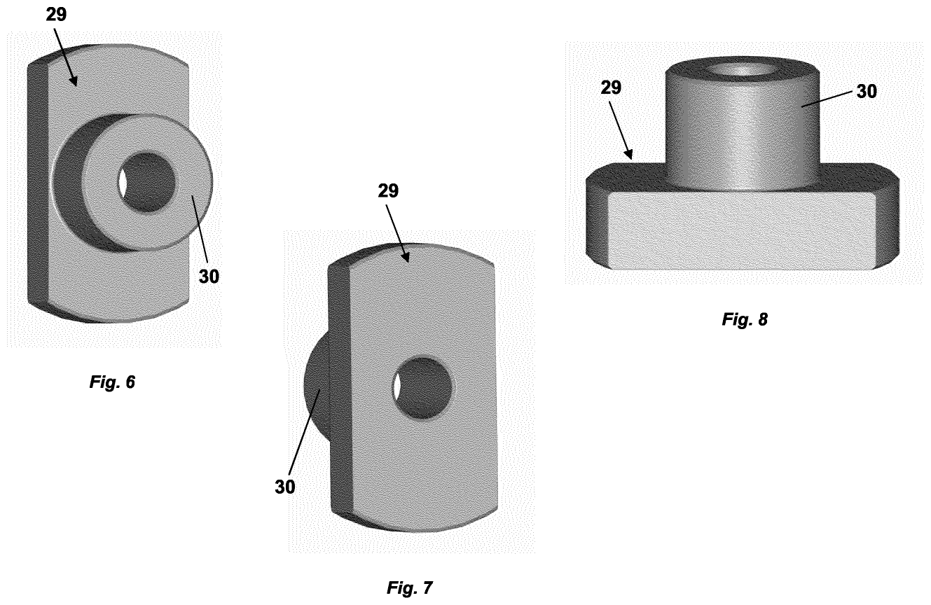

FIG. 6 shows a frontal, isometric view of an adapter element.

FIG. 7 shows a rear, isometric view of the adapter element according to FIG. 5.

FIG. 8 shows a lateral view of the adapter according to FIG. 5.

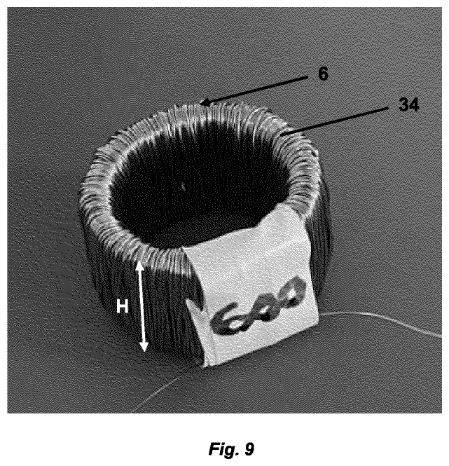

FIG. 9 shows a conductor loop.

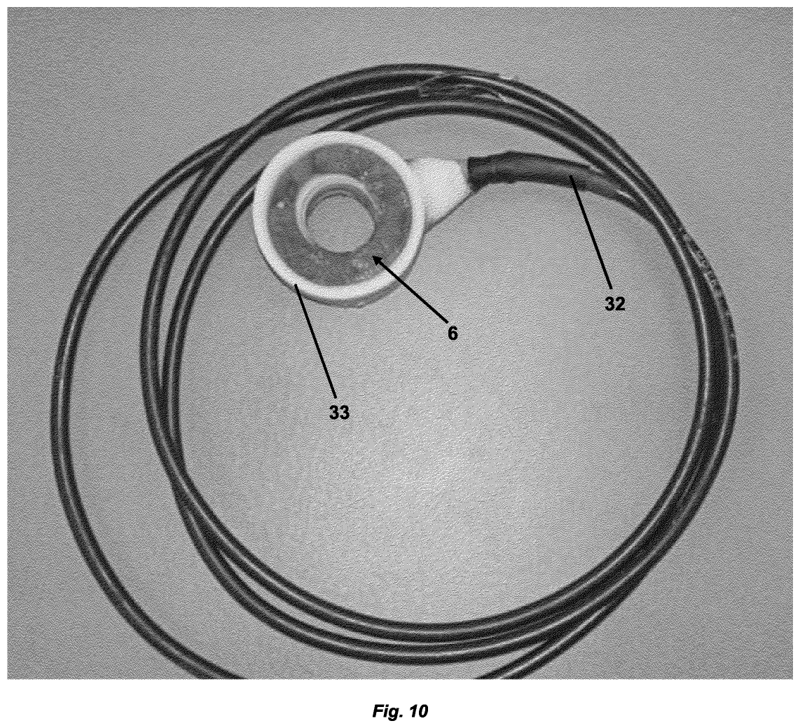

FIG. 10 shows a conductor loop disposed in a casing.

FIG. 1 shows a schematic representation of a monitoring system 15 with a power supply device 1 together with a current collector 7 designed as a pantograph and forming a part of the main conductor of a rail vehicle 24 (not shown in FIG. 1). The transmission electronics 5 is used to transmit the electrical energy from the conductor loop 6 to the consumer 2 in the form of an acquisition unit 23. Not shown here is the catenary to which the current collector 7 is connected via the contact strip of the current collector 7 to supply the rail vehicle 24 with power from the supply network. Also not shown in FIG. 1 is the rail vehicle 24, on whose roof the current collector 7 is disposed and which can be moved on the rails 18, which also form the ground of the system. FIG. 1 also shows that there is a maximum potential difference of 100 V at the current collector 7. In contrast, there is a potential difference of 15 kV between the current transfer point, i.e., the point at which the contact strip of the current collector 7 and the catenary (not shown) touch, and the ground potential. According to the embodiment shown, the conductor loop 6 generates an alternating voltage. This AC voltage is rectified with the component for rectification 10, the voltage also being limited with the aid of an active limiter 11. A voltage of 3.8 V is generated from the outlet voltage of the component for rectification 10, which can be between 0.35 V and 16 V, with the aid of the voltage transformation component 9, in this case a voltage converter. The capacitors 13 used as components for energy storage 13 are supplied via charging electronics 12, so that the acquisition unit 23 can be supplied with the necessary supply voltage of 3.3 V even when the rail vehicle 24 is at a standstill or during braking phases in operation, when the voltage drop on the bypass conductor 6 is too low. FIG. 1 thus shows an embodiment in which the current flows from the conductor loop 6 through a component for rectification 10 and a component for voltage limitation 11, then through a component for voltage transformation 9 and the charging electronics 12 to the acquisition unit 23.

Owing to the shown design of the power supply device 1, the acquisition unit 23 can be safely and reliably supplied with the DC voltage required to operate the acquisition unit 23 via an AC voltage tapped at the current collector 7. In addition to the acquisition unit 23, the active limiter 11, the rectifier 10 and the voltage converter 9 can also be supplied via the component for energy storage 13 of the charging electronics 12.

The initial ignition of the voltage converter 9 is generated via a pulse whose energy requirement can also be covered by the component for energy storage. In order to avoid unnecessary discharging of the component for energy storage, monitoring electronics 14 is provided which monitors the ignition of the voltage converter 9 and prevents unnecessary ignition processes, for example when the outlet voltage of the conductor loop 6 is unstable. The acquisition unit 23 has a sensor device 16 fixedly disposed on the rail vehicle and serving to monitor an operating unit 3, in this case a current collector 7, the acquisition unit 23 being used to record data for various attributes of the current collector 7. The data can be transmitted to an evaluation device (not shown), using the transmission device 17. For example, the condition of the contact strip of the current collector 7 can be determined and maintenance and/or replacement of the contact strips can be carried out in good time.

The functionality of the power supply system 1 shown in FIG. 2 essentially corresponds to the power supply device 1 shown in FIG. 1. FIG. 2 shows a power supply device 1 together with a current collector 7 which is designed as a pantograph and forms a part of the main conductor on a rail vehicle 24. The transmission electronics 5 serves for transmitting the electric energy from the conductor loop 6 to several consumers 2. Not shown is the catenary, to which the current collector 7 is connected via the contact strip of the current collector 7 for supplying the rail vehicle 24 with electric energy. According to the embodiments shown, the conductor loop 6 generates an alternating voltage. This alternating voltage can be rectified using a component for rectification 10 (not shown), the voltage being able to be limited with the aid of an active limiter 11 (not shown). With the aid of the components for voltage transformation 9, in this instance at least one buck converter and at least one boost converter, the supply voltage required for operation of the consumers 2 can be supplied to the consumers 2. The consumers 2 can be supplied with the required supply voltage by means of the capacitors 13 and/or the battery 31 even during downtimes of the rail vehicle 24 or during braking phases during operation when the voltage drop at the conductor loop 24 becomes too low.

A synopsis of FIGS. 3 and 4, with FIG. 4 showing detail A from FIG. 3, shows an option of disposing the fastening mechanism 8 on a current collector 7 designed as a pantograph. The current collector 7 is disposed on the roof of the rail vehicle 24 and has a base frame 20, a lower arm 21 and an upper arm 22, which are articulated by means of joints 25, 26. Owing to the articulated connection of the upper arm 22 to the lower arm 21 by means of the joint 26 and the articulated connection of the lower arm 21 to the base frame 20 by means of the joint 25, the contact strips 28 can be lifted towards and be made to abut against a catenary (not shown) or be lowered towards the roof of the rail vehicle 24. The fastening mechanism 8 is disposed on the base frame 20 close to the joint 25 and has a fastening element 27 for holding the conductor loop 6, in particular for holding by means of the adapter element 29 shown in FIGS. 4 to 7.

FIG. 5 shows an option for disposing the conductor loop 6 on a current collector 7 designed as a pantograph. The pantograph 6 is placed about a section of the conductor loop 4 designed as a live cable element 19. The, preferably flexible, cable element 19 serves for bridging the bearing of the joint 25. Specifically, the fastening mechanism 8 according to the embodiment shown is enlarged about a conductor loop 6, which is designed as an induction coil element. The conductor loop 6 is fixed about an adapter element 29, which is designed as a spacer bolt in this case. The adapter element 28 shown in FIGS. 5 to 8 has a hollow-cylindrical section 30 through which a fastening element 27 of the fastening mechanism 8 passes, the adapter element 29 being able to be fixed on, in particular screwed to, the base frame 20. The adapter element 29 is live. The outer measurements and height of the adapter element 29 complement each other and thus correspond to the inner measurements of the conductor loop 6. Alternatively, the conductor loop can also engage about any other live component of the current collector 7.

FIG. 9 shows a conductor loop 6 according to the invention consisting of a toroid and windings 34 disposed around the toroid and made of enameled copper wire. FIG. 9 shows that the height H of the toroid and/or the conductor loop 6 is defined in such a manner that the height H of the symmetry axis of the toroid and/or the conductor loop 6 is measured.

FIG. 10 shows the conductor loop 6 which is cast in a casing 33 and is connectable to the transmission electronics 5 (not shown) via the connective line 32.

1. A power supply device (1) for supplying power to a consumer (2) disposed on a rail vehicle (24), the consumer preferably being an acquisition unit (23) for monitoring rail vehicles (24), in particular for monitoring an operating unit (3), the rail vehicle (24) having at least one conductor (4) and the power supply device (1) being configured for generating a supply voltage of the consumer (2) from a voltage applied to the conductor (4), wherein transmission electronics (5) and at least one conductor loop (6) connectable in an electrically conductive manner to the consumer (2) via the transmission electronics (5) and having n windings are comprised, and the transmission electronics (5) is disposed between the conductor loop (6) and the consumer (2), and the conductor loop (6) being disposed in such a manner about the conductor (4) that the conductor loop (6) generates an outlet voltage, the transmission electronics (5) being designed in such a manner that the transmission electronics (5) generates the supply voltage of the consumer (2) from the outlet voltage of the conductor loop (6).

2. The power supply device according to claim 1, wherein the transmission electronics (5) has a component for voltage transformation (9).

3. The power supply device according to claim 1, wherein the transmission electronics (5) has a component for rectification (10).

4. The power supply device according to claim 1, wherein the transmission electronics (5) has charging electronics (12) comprising at least one component for energy storage.

5. The power supply device according to claim 1, further including monitoring electronics (14) for monitoring the component for voltage transformation (9).

6. The power supply device according claim 1, wherein the at least one conductor loop (6) is disposed about a conductor (4) disposed on a current collector (7).

7. The power supply device according to claim 1, wherein the at least one conductor loop is disposed on the base frame (20), the upper arms (22) or the lower arms (21) of the current collector (7).

8. The power supply device according to claim 1, further including a power generation unit selected from the group consisting of a fuel cell, a photoelectric generator, a piezoelectric generator, a kinetic generator and a thermoelectric generator.

9. A monitoring system (15) having a power supply device (1) according to claim 1 and a consumer designed as an acquisition unit (23) and serving to monitor rail vehicles data being acquired for different attributes of the corresponding operating units (3) by means of the acquisition device (2).

10. The monitoring system according to claim 9, wherein the acquisition unit (2) has a sensor device (16) fixedly disposed on the corresponding operating unit (3) or the rail vehicle (24).

11. The monitoring system according to claim 9, wherein the acquisition unit (23) has a transmission device (17) fixedly disposed on the corresponding operating unit (3) or the rail vehicle (24).

12. The monitoring system according to claim 9, wherein the acquisition unit (2) has a time sensor and a position sensor so that an acquisition time and a location of the corresponding operating unit (3) is determinable.

13. The monitoring system according to claim 9, wherein the monitoring system (15) has an energy meter.

14. The monitoring system according to claim 9, wherein the monitoring system (15) comprises at least one operating unit (3).

15. A method for supplying power to a consumer (2) disposed on a rail vehicle (24), comprising applying a first voltage to a conductor (4) of the rail vehicle (24), and a second voltage being tapped at the conductor (4) as an output voltage of the conductor loop (6) by means of at least one conductor loop (6) and the output voltage of the conductor loop (6) being used for supplying power to the consumer (2).

16. The method for supplying power according to claim 15, further including the step of generating the supply voltage required by the consumer (2) by the voltage transformation of the outlet voltage of the conductor loop (6).

17. The method for supplying power according claim 15, further including the step of rectifying the output voltage of the at least one conductor loop (6).

18. The method for supplying power according to claim 15, further including the step of providing the supply voltage of the consumer (2) at least one component for energy storage (12).

19. The method for supplying power according to claim 15, further including the step of detecting and recording the traveling current or electric arcs or a traveling profile.
